(19) United States
(12) Patent Application Publication
(10) Pub. No.: US 2017/0171045 A1
(43) Pub. Date: Jun. 15, 2017

(54) OPTIMIZING NETWORK TRAFFIC BY TRANSPARENTLY INTERCEPTING A TRANSPORT LAYER CONNECTION AFTER CONNECTION ESTABLISHMENT

(71) Applicant: Riverbed Technology, Inc., San Francisco, CA (US)

(72) Inventor: Kand Ly, San Francisco, CA (US)

(73) Assignee: Riverbed Technology, Inc., San Francisco, CA (US)

(21) Appl. No.: 14/967,045

(22) Filed: Dec. 11, 2015

(51) Int. Cl. H04L 12/26; H04L 29/08

(52) U.S. Cl. CPC H04L 43/08; H04L 69/326; H04L 67/14; H04L 67/02

(57) ABSTRACT

Systems and techniques are described for optimizing network traffic by transparently intercepting a transport layer connection after connection establishment. Specifically, an intermediary device can monitor communications between two computers while a transport layer connection that uses a transport layer protocol is being established between the two computers. While monitoring communications, the intermediary device can save transport layer protocol state information associated with the transport layer connection that is being established. The intermediary device can then use the saved transport layer protocol state information to transparently intercept the transport connection.

### TECHNICAL FIELD

This disclosure relates to computer networking. More specifically, this disclosure relates to optimizing network traffic by transparently intercepting a transport layer connection after connection establishment.

### BACKGROUND

Related Art

Enterprise networks can include one or more wide-area networks (WANs) that interconnect offices that can be distributed over a large geographical area. Some enterprise networks use WAN optimization devices to improve network performance. WAN optimization devices may operate singly or in pairs at each side of a WAN connection to optimize network traffic. WAN optimization devices are referred to in the art by many different terms, including, but not limited to, transaction accelerators, WAN optimizers, WAN optimization controllers (WOCs), wide-area data services (WDS) appliances, WAN traffic optimizers (WTOs), and protocol accelerators or optimizers.

Techniques for optimizing network traffic to improve network performance in reading and/or writing data over a network are referred to in the art by many different terms, including, but not limited to, WAN acceleration, transaction acceleration, transaction pipelining, protocol pipelining, request prediction, application flow acceleration, and protocol acceleration. In this disclosure, the term “WAN optimization device” is used to refer to such devices and applications and “WAN optimization” is used to refer to such techniques.

In some scenarios it is difficult or impossible to determine whether or not to perform network optimization based on the Internet Protocol (IP) address. For example, software as a service (SaaS) services running on a content delivery network (CDN) are not easily identifiable because a CDN serves multiple services out of its edges; thus, intercepting connections based on their destination IP address does not work because there is no way to tell which SaaS service they are for. Because SaaS services running on CDN are not easily identifiable, it is difficult to optimize traffic for such services. This problem with optimizing network traffic generally exists for any website or service that cannot be reliably identified based on the IP address or where multiple services are served out of a single IP address (e.g., when users connect to the Internet through a proxy or when a SaaS serves multiple services out of the same server).

### SUMMARY

Some embodiments described herein provide systems and techniques for optimizing network traffic by transparently intercepting a transport layer connection after connection establishment. Specifically, a first intermediary device and a second intermediary device can optimize traffic between two computers—e.g., a first computer and a second computer—by transparently intercepting a transport layer connection after the transport layer connection has been established between the two computers. A portion or all of network traffic between the first computer and the second computer may pass through the first intermediary device and the second intermediary device. In some embodiments, the first computer can be a client computer, the second computer can be a web server (e.g., a SaaS server), the intermediary devices can be WAN accelerators, and the network over which the first computer communicates with the second computer can include a CDN.

Specifically, in some embodiments, the first intermediary device can monitor communications between a first computer and a second computer while a transport layer connection that uses a transport layer protocol is being established between the first computer and the second computer, wherein the first intermediary device can save transport layer protocol state information associated with the transport layer connection that is being established. Once the transport layer connection has been established between the first computer and the second computer, the first intermediary device can analyze at least one application layer message that is sent over the transport layer connection. In some embodiments, the at least one application layer message can be a Hypertext Transfer Protocol (HTTP) request message, a Secure Sockets Layer (SSL) client hello message, or a proxy connect request message.

Next, the first intermediary device can determine if the transport layer connection is to be optimized based on a result of said analyzing. In some embodiments, the at least one application layer message can include a server hostname, and analyzing the at least one application layer message can involve determining if network traffic to the server hostname is to be optimized. Specifically, the first intermediary device may maintain a list of hostnames, and determining if network traffic to a given server hostname is to be optimized can involve checking if the given server hostname is in the list of hostnames.

If the first intermediary device determines that the transport layer connection is to be optimized, then the first intermediary device can (1) transparently intercept the transport layer connection by using the saved transport layer protocol state information associated with the transport layer connection, (2) establish an inner connection between the first intermediary device and the second intermediary device, (3) receive first network traffic sent from the first computer to the second computer over the transport layer connection, (4) optimize the first network traffic, and (5) send the optimized first network traffic to the second intermediary device over the inner connection.

In some embodiments, the first intermediary device can save an initial state of the transport layer stack as it exists on the second computer, and temporarily store transport layer packets that are sent over the transport layer connection. In these embodiments, the first intermediary device can transparently intercept the transport layer connection by (1) replicating the initial state of the transport layer stack on the intermediary device, and (2) replaying the stored transport layer packets to the transport layer stack on the intermediary device, thereby putting the transport layer stack on the intermediary device in the same state as the transport layer stack of the end computer.

Upon receiving the optimized first network traffic from the first intermediary device, the second intermediary device can reconstruct the first network traffic based on the optimized first network traffic, and send the reconstructed first network traffic to the second computer Likewise, on the return path, the second intermediary device can receive second network traffic from the second computer, the second intermediary device can optimize the second network traffic, and the second intermediary device can send the optimized second network traffic to the first intermediary device over the inner connection. Upon receiving the optimized second network traffic from the second intermediary device, the first intermediary device can reconstruct the second network traffic based on the optimized second network traffic, and the first intermediary device can send the reconstructed second network traffic to the first computer over the transport layer connection.

### BRIEF DESCRIPTION OF THE FIGURES

FIG. 1A illustrates an example of a network in accordance with some embodiments described herein.

FIG. 1B illustrates an example of a network in accordance with some embodiments described herein.

FIG. 2 illustrates a process for optimizing network traffic in accordance with some embodiments described herein.

FIG. 3 illustrates an apparatus in accordance with some embodiments described herein.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein. In this disclosure, when the term “and/or” is used with a list of entities, it refers to all possible combinations of the list of entities. For example, the phrase “X, Y, and/or Z” covers the following embodiments: (1) only X; (2) only Y; (3) only Z; (4) X and Y; (5) X and Z; (6) Y and Z; and (7) X, Y, and Z.

According to one definition, a computer is any device that is capable of performing computations. In some embodiments, a computer can include a processing mechanism that is capable of executing instructions stored on a storage medium. Examples of computers include, but are not limited to, smartphones, handheld computers, laptop computers, desktop computers, distributed computers, printers, appliances, etc.

According to one definition, a network is a set of one or more interconnected devices that is capable of delivering information from one computer to another computer. Examples of networks include, but are not limited to, wireless and wired networks, local area networks (LANs), metropolitan area networks (MANs), WANs, CDNs, private networks, public networks, intranets, the Internet, subnets, etc.

Communication between two nodes of a network is typically accomplished using a layered software architecture, which is often referred to as a networking software stack or simply a networking stack. As is true of any data processing function, a given functionality in a networking stack can be implemented using hardware or software or a combination thereof. The decision to implement a specific functionality in hardware or software is typically based on a tradeoff between performance and cost.

Each layer is usually associated with one or more protocols which define the rules and conventions for processing packets in that layer. Each lower layer performs a service for the layer immediately above it to help with processing packets, and each layer typically adds a header (control data) that allows peer layers to communicate with one another. At the sender, this process of adding layer specific headers is usually performed at each layer as the payload moves from higher layers to lower layers. The receiving host generally performs the reverse of this process by processing headers of each layer as the payload moves from the lowest layer to the highest layer.

A data link layer (or link layer for short) can be defined as a layer that manages a communication channel between adjacent communication devices. For example, if two routers are connected to each other via a cable, then the link layer would typically manage the communication channel between these two routers. The Ethernet layer is an example of a link layer. A network layer can be defined as a layer that enables communication between any two devices across the network. For example, the Internet Protocol (IP) layer is an example of a network layer that enables communication between two routers in an IP network.

A transport layer can be defined as a layer that uses the network layer to establish a reliable connection between two devices in the network. A transport layer can retransmit a packet from the source device to the destination device if the source device does not receive an acknowledgment from the destination device that the packet was successfully received at the destination device. A transport layer can also increase or decrease the rate at which packets are sent between the source and the destination devices depending on network congestion. A transport layer is stateful because it needs to keep track of the state of the communication between the source and destination devices to implement reliable packet delivery. For example, a transport layer may need to keep track of packet identifiers, serial numbers, and/or timestamps for packets that have been sent from the source device to the destination device, but for which acknowledgments have not been received from the destination device. Transport Control Protocol (TCP) is an example of a transport layer protocol.

An application layer can be defined as a layer that uses a transport layer protocol to send and receive messages between applications executing on devices. An application layer protocol defines the rules and conventions that an application uses for communicating with its peers. Hypertext Transfer Protocol (HTTP) is an example of an application layer protocol that uses TCP to exchange messages between a web client and a web server, e.g., a web client can use HTTP to send a web page request to a web server, and the web server can use HTTP to supply the contents of the requested web page to the web client.

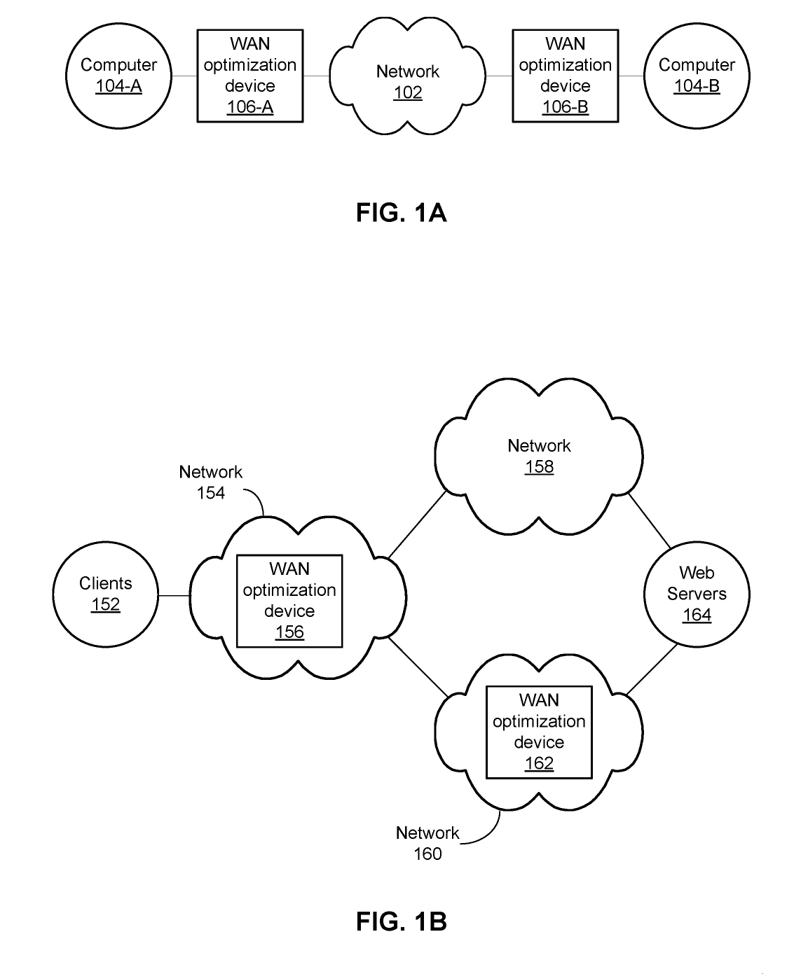

FIG. 1A illustrates an example of a network in accordance with some embodiments described herein. Although some of the examples described in this disclosure are in the context of a WAN, the disclosed systems and techniques can generally be used to improve performance of any type of network. Computer 104-A can be located at a company's headquarters or a company's regional office, and can be part of a network that includes one or more clients, routers and WAN optimization devices such as WAN optimization device 106-A.

Computer 104-B can be located in a data center that can include servers and data storage systems (not shown in FIG. 1A) for the company's enterprise network, and can include WAN optimization device 106-B.

At least some communications between computers 104-A and 104-B may pass through WAN optimization devices 106-A and 106-B, and network 102. WAN optimization device 106-A can establish a connection with WAN optimization device 106-B, and can use the connection to optimize at least some communications between computers 104-A and 104-B. For example, WAN optimization devices 106-A and 106-B can intercept a connection between computers 104-A and 104-B, and establish the following two local connections: a first local connection between WAN optimization device 106-A and computer 104-A, and a second local connection between WAN optimization device 106-B and computer 106-B. The interception may be performed transparently, i.e., computers 104-A and 104-B may communicate with each other as if they had established an end-to-end connection without realizing that, in fact, the end-to-end connection was split into multiple connections by WAN optimization devices 106-A and 106-B.

WAN optimization devices 106-A and 106-B can then use the three connections—the connection between the two WAN optimization devices and the two local connections—to optimize communications between computers 104-A and 104-B. For example, data sent by computer 104-A to computer 104-B can be received at WAN optimization device 106-A. Next, WAN optimization device 106-A can transform the data (e.g., by performing de-duplication) and send the transformed data to WAN optimization device 106-B. The transformation can significantly reduce the size of the data, thereby reducing the amount of bandwidth required to communicate the data over network 102. WAN optimization device 106-B can then perform an inverse transformation to recover the original data. The recovered original data can then be sent from WAN optimization device 106-B to computer 104-B. Likewise, in the return path (i.e., when computer 104-B sends data back to computer 104-A), the data can be transformed by WAN optimization device 106-B and the original data can be subsequently recovered by WAN optimization device 106-A.

In addition to reducing the amount of bandwidth required for communicating data over network 102, WAN optimization devices can also reduce latency by, for example, performing intelligent prefetching. For example, a WAN optimization device (e.g., WAN optimization device 106-A) can intelligently prefetch data from a server (e.g., computer 104-B) in a data center and provide the data to a client (e.g., computer 104-A) when a request for the data from the client is intercepted. Performing intelligent prefetching can significantly reduce latency because the round trip time from the client to its local WAN optimization device can be significantly less than the round trip time from the client to the data center.

FIG. 1B illustrates an example of a network in accordance with some embodiments described herein. Networks 154, 158, and 160 can enable computers to communicate with each other. Network 154 may include WAN optimization device 156 and network 160 may include WAN optimization device 162. A router in network 154 may route network traffic from clients 152 based on one or more parameters that can include the destination address, the type of application, the user, etc. Specifically, traffic between clients 152 and web servers 164 (e.g., a set of SaaS servers) can be routed along a path that goes through networks 154 and 158 or along a path that goes through networks 154 and 160. If the network traffic between clients 152 and web servers 164 passes through WAN optimization devices 156 and 162, then these WAN optimization devices can optimize the network traffic as explained in reference to FIG. 1A.

In some cases, only a portion of the network traffic between clients 152 and web servers 164 that passes through WAN optimization devices 156 and 162 is desired to be optimized. Specifically, web servers 164 may provide multiple web services (e.g., multiple SaaS services), and the network traffic for only some of those services may be desired to be optimized using WAN optimization devices (e.g., because trying to optimize all of the network traffic may unnecessarily burden the WAN optimization devices). The number and types of devices shown in FIGS. 1A-1B are for illustration purposes only and are not intended to limit the scope of this disclosure. Some systems and techniques for optimizing network traffic are now described.

### Optimizing Network Traffic

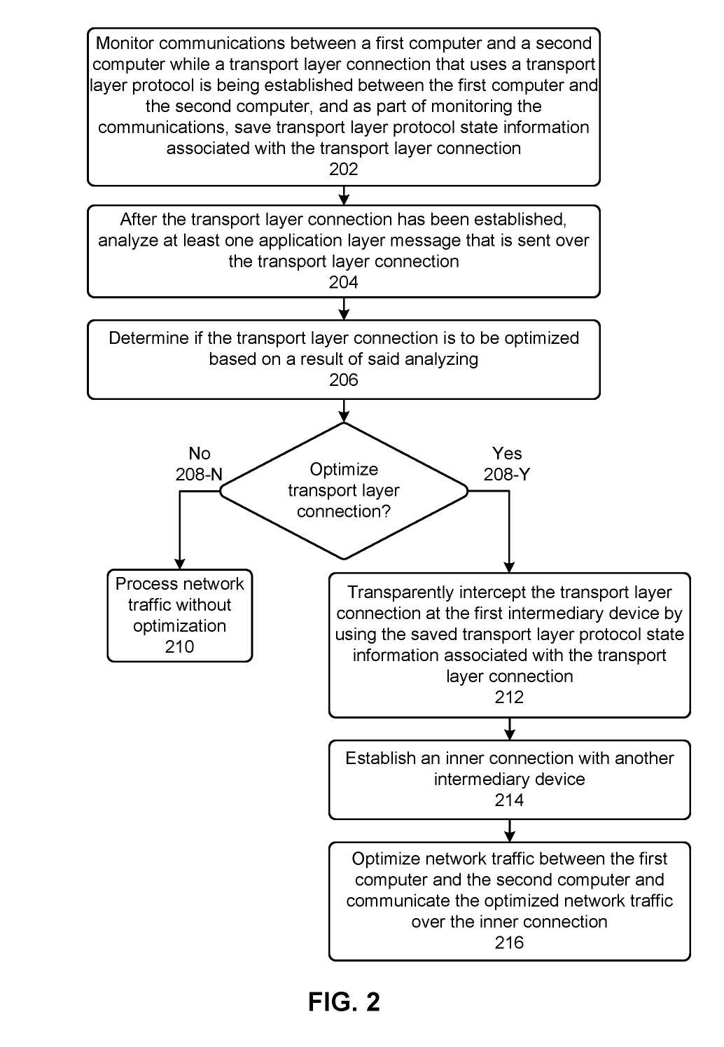

FIG. 2 illustrates a process for optimizing network traffic in accordance with some embodiments described herein. In some embodiments, at least some traffic and possibly all network traffic between a first computer and a second computer passes through the first intermediary device and the second intermediary device. In these embodiments, the first intermediary device needs to determine whether or not to optimize network traffic for a given transport layer connection. However, in order to determine this, the first intermediary device may need to analyze application layer messages that are sent over the established transport layer connection, and then transparently intercept the established transport layer connection. The flowchart in FIG. 2 illustrates a process for doing so. In some embodiments, the first computer can be a client computer (e.g., a client in clients 152 in FIG. 1B), the second computer can be a server computer (e.g., a web server in web servers 164 in FIG. 1B), the first intermediary device can be a client-side WAN accelerator (e.g., WAN optimization device 156 in FIG. 1B), and the second intermediary device can be a server-side WAN accelerator (e.g., WAN optimization device 162 in FIG. 1B).

The process can begin by a first intermediary device monitoring communications between a first computer and a second computer while a transport layer connection that uses a transport layer protocol is being established between the first computer and the second computer, and as part of monitoring the communications, saving transport layer protocol state information associated with the transport layer connection (operation 202).

In some embodiments, an intermediary device can discover other intermediary devices in the network. Specifically, the first intermediary device can discover the second intermediary device during the transport layer connection establishment process, e.g., by piggybacking probe requests and responses on the sequence of packets that are used for establishing the transport layer connection. Specifically, an auto-discovery process that can be used by the first intermediary device to discover the second intermediary device is taught in U.S. Pat. No. 7,318,100, entitled “Cooperative proxy auto-discovery and connection interception,” by inventors Michael J. Demmer, Steven McCanne, and Alfred Landrum, which is herein incorporated by reference in its entirety for all purposes. In general, an intermediary device can use any technique to discover and/or learn about other intermediary devices. For example, in some embodiments, an intermediary device can send probe requests and receive probe responses via a separate protocol, i.e., the probe requests and responses may not be piggybacked with the transport layer packets. Intermediary devices may also be pre-configured (e.g., by a user) so that a given intermediary device knows the existence and identities of other intermediary devices in the network.

After the transport layer connection has been established between the first computer and the second computer, the first intermediary device can then analyze at least one application layer message that is sent over the transport layer connection (operation 204). Next, the first intermediary device can determine if the transport layer connection is to be optimized based on a result of said analyzing (operation 206).

In general, any information contained in one or more application layer messages can be analyzed to determine whether or not the transport layer connection is to be optimized. For example, the at least one application layer message can include a server hostname, and analyzing the at least one application layer message can involve determining if network traffic to the server hostname is to be optimized. Specifically, the first intermediary device may have a list of hostnames for which network traffic is to be optimized, and the first intermediary device can determine if network traffic to the server hostname is to be optimized by checking if the server hostname that was included in the application layer message is present in the list. Examples of application layer messages that can contain hostnames include, but are not limited to, an HTTP request message, an SSL client hello message, and a proxy connect request message. In some embodiments, the list of hostnames can include hostnames that have wild cards, e.g., “*.google.com” which will match any hostname that ends with “google.com.” Some embodiments can match a specific service, e.g., “www.google.com/mail,” instead of just matching the hostname. In yet another embodiment, one or more strings in one or more application layer messages can be matched against one or more regular expressions to determine whether or not the transport layer connection is to be optimized.

If the first intermediary device determines that the transport layer connection is not to be optimized (branch 208-N), then the first intermediary device can do nothing, e.g., the first intermediary device can continue processing network traffic as usual, i.e., without optimization (operation 210). On the other hand, if the first intermediary device determines that the transport layer connection is to be optimized (branch 208-Y), then the first intermediary device can transparently intercept the transport layer connection at the first intermediary device by using the saved transport layer protocol state information associated with the transport layer connection (operation 212).

Next, the first intermediary device can establish an inner connection with another intermediary device (operation 214), and optimize network traffic between the first computer and the second computer and communicate the optimized network traffic over the inner connection (operation 216). Specifically, in operation 216, the first intermediary device can (1) receive first network traffic sent from the first computer to the second computer over the transport layer connection, (2) optimize the first network traffic, and (3) send the optimized first network traffic to the second intermediary device over the inner connection.

Upon receiving the optimized first network traffic from the first intermediary device, the second intermediary device can reconstruct the first network traffic based on the optimized first network traffic. Next, the second intermediary device can send the reconstructed first network traffic to the second computer. On the return path, the second intermediary device can receive second network traffic from the second computer. Next, the second intermediary device can optimize the second network traffic, and send the optimized second network traffic to the first computer over the inner connection. Upon receiving the optimized second network traffic, the first intermediary device can reconstruct the second network traffic based on the optimized second network traffic, and send the reconstructed second network traffic to the first computer over the transport layer connection.

In operation 212, when the first intermediary device transparently intercepts the transport layer connection, the first computer can continue to operate as if the transport layer connection with the second computer is operating as usual (i.e., the interception is “transparent”). However, in actuality, the first intermediary device has taken over the transport layer connection, i.e., the first intermediary device is acting as if it were the second computer. Specifically, any transport layer connection messages that the first computer would expect to receive from the second computer (e.g., acknowledgment messages for packets that were sent from the first computer to the second computer) can be sent by the first intermediary device to the first computer.

In some embodiments, the remaining portion of the transport layer connection, i.e., from the first intermediary device to the second computer can be terminated and replaced by an inner connection between the first intermediary device and the second intermediary device, and a new transport layer connection between the second intermediary device and the second computer. The new transport layer connection can retain the same network layer and transport layer addresses (e.g., the same IP address and TCP port numbers), but re-initialize the transport layer protocol state. Next, the two intermediary devices can optimize the network traffic that is sent between the first and second computers (e.g., the client and the server) over the inner connection.

In some embodiments, the second intermediary device can (just like the first intermediary device) transparently intercept the transport layer connection by using the saved transport layer protocol state information associated with the transport layer connection. In other words, the second computer can continue to operate as if the transport layer connection with the first computer were operating as usual. However, in actuality, the second intermediary device has taken over the transport layer connection, i.e., the second intermediary device is acting as if it were the first computer. Any transport layer connection messages that the second computer would expect to receive from the first computer can be sent by the second intermediary device to the second computer. In this embodiment, the first and second intermediary devices transparently take over their respective portions of the established transport layer connection, and establish an inner connection between them. Next, the two intermediary devices can optimize the network traffic that is sent between the first and second computers (e.g., the client and the server) over the inner connection.

As explained above, transport layer protocols are typically stateful. Specifically, a transport layer can include data structures that keep track of timers, identifiers, sequence numbers, and any other pieces of information that are required for proper operation of the transport layer protocol. Typically, the computers at the two ends of the transport layer connection store this state information (e.g., clients 152 and web servers 164 in FIG. 1B). However, in some embodiments described herein, an intermediary device (e.g., WAN optimization devices 156 and/or 162) can also store the state information by analyzing the transport layer connection packets that are passing through the intermediary device. The intermediary device can then transparently intercept the transport layer connection by populating the appropriate data structures in its own transport layer stack based on the stored state information.

Specifically, in some embodiments, an intermediary device can store the initial state of the transport layer stack as it exists on one of the end computers of the transport layer connection (e.g., WAN optimization device 156 in FIG. 1B can store the initial state of the transport layer stack as it exists on one of the web servers 164) and store transport layer packets that are sent over the transport layer connection. Note that the intermediary device can determine the initial state of the transport layer stack by monitoring communications between two computers while a transport layer connection that uses a transport layer protocol is being established between the two computers. Next, the intermediary device can transparently intercept the transport layer connection by (1) replicating the initial state of the transport layer stack on the intermediary device, and (2) replaying the stored transport layer packets to the transport layer stack on the intermediary device, thereby putting the transport layer stack on the intermediary device in the same state as the transport layer stack of the end computer.

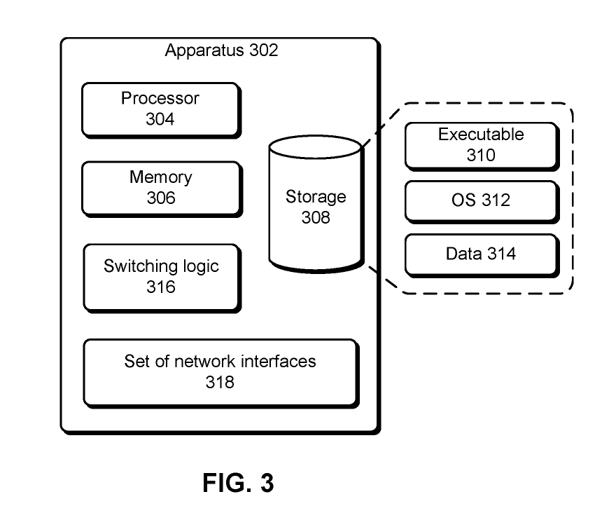

FIG. 3 illustrates an apparatus in accordance with some embodiments described herein. Apparatus 302 comprises processor 304, memory 306 (e.g., a volatile or non-volatile random access memory), and storage 308 (e.g., a flash memory device or a disk drive). Storage 308 can store executable 310, operating system 312, and data 314. Apparatus 302 also includes switching logic 316 and set of network interfaces 318. The components in apparatus 302 can communicate with one another using a communication mechanism, e.g., a bus, a backplane, and/or a switching fabric.

Executable 310 can include instructions that, when executed by processor 304, cause apparatus 302 to perform one or more methods that are implicitly or explicitly described in this disclosure. Data 314 can include any data that is inputted into or outputted by executable 310. Set of network interfaces 318 can be used to transmit data to and/or receive data from other communication devices. Switching logic 316 can forward network traffic received on one or more network interfaces in accordance with switching/forwarding/routing information stored in apparatus 302.

The above description is presented to enable any person skilled in the art to make and use the embodiments. Various modifications to the disclosed embodiments will be readily apparent to those skilled in the art, and the general principles defined herein are applicable to other embodiments and applications without departing from the spirit and scope of the present disclosure. Thus, the present invention is not limited to the embodiments shown, but is to be accorded the widest scope consistent with the principles and features disclosed herein.

The data structures and code described in this disclosure can be partially or fully stored on a non-transitory computer-readable storage medium and/or a hardware module and/or hardware apparatus. A non-transitory computer-readable storage medium includes all computer-readable storage mediums with the sole exception of a propagating electromagnetic wave or signal. Specifically, a non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media, now known or later developed, that are capable of storing code and/or data. Hardware modules or apparatuses described in this disclosure include, but are not limited to, application-specific integrated circuits (ASICs), field-programmable gate arrays (FPGAs), dedicated or shared processors, and/or other hardware modules or apparatuses now known or later developed.

The methods and processes described in this disclosure can be partially or fully embodied as code and/or data stored in a non-transitory computer-readable storage medium or device, so that when a computer system reads and executes the code and/or data, the computer system performs the associated methods and processes. The methods and processes can also be partially or fully embodied in hardware modules or apparatuses. Note that the methods and processes can be embodied using a combination of code, data, and hardware modules or apparatuses.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for optimizing network traffic by transparently intercepting a transport layer connection after connection establishment, the method comprising:
a first intermediary device monitoring communications between a first computer and a second computer while a transport layer connection that uses a transport layer protocol is being established between the first computer and the second computer, wherein the first intermediary device saves transport layer protocol state information associated with the transport layer connection during said monitoring;
after the transport layer connection has been established between the first computer and the second computer, the first intermediary device analyzing at least one application layer message that is sent over the transport layer connection; and
the first intermediary device determining if the transport layer connection is to be optimized based on a result of said analyzing, and if so,
the first intermediary device transparently intercepting the transport layer connection at the first intermediary device by using the saved transport layer protocol state information associated with the transport layer connection,
the first intermediary device establishing an inner connection between the first intermediary device and a second intermediary device,
the first intermediary device receiving first network traffic sent from the first computer to the second computer over the transport layer connection,
the first intermediary device optimizing the first network traffic, and
the first intermediary device sending the optimized first network traffic to the second intermediary device over the inner connection.

2. The method of claim 1, wherein all network traffic between the first computer and the second computer passes through the first intermediary device and the second intermediary device.

3. The method of claim 2, wherein the first computer is a client computer, the second computer is a server computer, the first intermediary device is a client-side wide area network (WAN) accelerator, and the second intermediary device is a server-side WAN accelerator.

4. The method of claim 1, wherein the at least one application layer message includes a server hostname, and wherein said analyzing the at least one application layer message comprises determining if network traffic to the server hostname is to be optimized.

5. The method of claim 4, wherein the at least one application layer message is a Hypertext Transfer Protocol (HTTP) request message.

6. The method of claim 4, wherein the at least one application layer message is a Secure Sockets Layer (SSL) client hello message.

7. The method of claim 4, wherein the at least one application layer message is a proxy connect request message.

8. The method of claim 1, wherein during said monitoring, the first intermediary device saves an initial transport layer protocol state that corresponds to an initial transport layer protocol state of a transport layer protocol stack on the second computer, wherein the first intermediary device temporarily stores transport layer packets that are sent over the transport layer connection, and wherein transparently intercepting the transport layer connection comprises:
setting a state of a transport layer protocol stack on the first intermediary device based on the saved initial transport layer protocol state; and
replaying the stored transport layer packets to the transport layer protocol stack on the first intermediary device, thereby putting the transport layer protocol stack on the first intermediary device in a same state as the transport layer protocol stack of the second computer.

9. The method of claim 1, further comprising:
the second intermediary device reconstructing the first network traffic based on the optimized first network traffic; and
the second intermediary device sending the reconstructed first network traffic to the second computer.

10. The method of claim 9, further comprising:
the second intermediary device receiving second network traffic from the second computer;
the second intermediary device optimizing the second network traffic;
the second intermediary device sending the optimized second network traffic to the first intermediary device over the inner connection;
the first intermediary device reconstructing the second network traffic based on the optimized second network traffic; and
the first intermediary device sending the reconstructed second network traffic to the first computer over the transport layer connection.

11. A first intermediary device, comprising:
a processor; and
a non-transitory storage medium storing instructions that, when executed by the processor, cause the first intermediary device to perform a method for optimizing network traffic by transparently intercepting a transport layer connection after connection establishment, the method comprising:
monitoring communications between a first computer and a second computer while a transport layer connection that uses a transport layer protocol is being established between the first computer and the second computer;
saving transport layer protocol state information associated with the transport layer connection during said monitoring;
after the transport layer connection has been established between the first computer and the second computer, analyzing at least one application layer message that is sent over the transport layer connection; and
determining if the transport layer connection is to be optimized based on a result of said analyzing, and if so,
transparently intercepting the transport layer connection at the first intermediary device by using the saved transport layer protocol state information associated with the transport layer connection,
establishing an inner connection between the first intermediary device and a second intermediary device,
receiving first network traffic sent from the first computer to the second computer over the transport layer connection,
optimizing the first network traffic, and
sending the optimized first network traffic to the second intermediary device over the inner connection.

12. The first intermediary device of claim 11, wherein all network traffic between the first computer and the second computer passes through the first intermediary device and the second intermediary device.

13. The first intermediary device of claim 12, wherein the first computer is a client computer, the second computer is a server computer, the first intermediary device is a client-side wide area network (WAN) accelerator, and the second intermediary device is a server-side WAN accelerator.

14. The first intermediary device of claim 11, wherein the at least one application layer message includes a server hostname, and wherein said analyzing the at least one application layer message comprises determining if network traffic to the server hostname is to be optimized.

15. The first intermediary device of claim 14, wherein the at least one application layer message is a Hypertext Transfer Protocol (HTTP) request message.

16. The first intermediary device of claim 14, wherein the at least one application layer message is a Secure Sockets Layer (SSL) client hello message.

17. The first intermediary device of claim 14, wherein the at least one application layer message is a proxy connect request message.

18. The first intermediary device of claim 11, wherein saving transport layer protocol state information comprises saving an initial transport layer protocol state that corresponds to an initial transport layer protocol state of a transport layer protocol stack on the second computer.

19. The first intermediary device of claim 18, wherein the method further comprises storing transport layer packets that are sent over the transport layer connection.

20. The first intermediary device of claim 19, wherein transparently intercepting the transport layer connection comprises:
setting a state of a transport layer protocol stack on the first intermediary device based on the saved initial transport layer protocol state; and
replaying the stored transport layer packets to the transport layer protocol stack on the first intermediary device, thereby putting the transport layer protocol stack on the first intermediary device in a same state as the transport layer protocol stack of the second computer.

21. A non-transitory storage medium storing instructions that, when executed by a network accelerator, cause the network accelerator to perform a method for optimizing network traffic by transparently intercepting a transport layer connection after connection establishment, the method comprising:
monitoring communications between a first computer and a second computer while a transport layer connection that uses a transport layer protocol is being established between the first computer and the second computer;
saving transport layer protocol state information associated with the transport layer connection during said monitoring;
after the transport layer connection has been established between the first computer and the second computer, analyzing at least one application layer message that is sent over the transport layer connection; and
determining if the transport layer connection is to be optimized based on a result of said analyzing, and if so,
transparently intercepting the transport layer connection at the first intermediary device by using the saved transport layer protocol state information associated with the transport layer connection,
establishing an inner connection between the first intermediary device and a second intermediary device,
receiving first network traffic sent from the first computer to the second computer over the transport layer connection,
optimizing the first network traffic, and
sending the optimized first network traffic to the second intermediary device over the inner connection.
